(19) United States
(12) Patent Application Publication
(10) Pub. No.: US 2026/0356051 A1
(43) Pub. Date: Nov. 12, 2026

(54) FIBROUS PREFORM WITH A THICKNESS VARIATION HAVING YARN CROSSINGS

(71) Applicant: SAFRAN CERAMICS, LE HAILLAN (FR)

(72) Inventors: Marie LEFEBVRE, MOISSY CRAMAYEL (FR); Aline PLANCKEEL, MOISSY CRAMAYEL (FR); Dominique Marie Christian COUPE, MOISSY CRAMAYEL (FR)

(21) Appl. No.: 19/131,466

(22) PCT Filed: Nov. 21, 2023
(86) PCT No.: PCT/FR2023/000177

§ 371 Date: May 20, 2025

(30) Foreign Application Priority Data
Nov. 21, 2022 (FR) 2212073

(51) Int. Cl. B29C 70/22; B29C 70/48; B29K 105/08; B29L 31/08

(52) U.S. Cl. CPC B29C 70/222; B29C 70/48; B29K 2105/0845; B29L 2031/082

(57) ABSTRACT

A fibrous preform produced by weaving between warp yarns and weft yarns, the preform including first and second portions connected by a transition portion, the first portion being thicker than the second portion in a thickness direction, each portion including, in the thickness direction, a core part provided between two surface parts, the core part of the first portion including a plurality of first warp yarns and a plurality of second warp yarns, wherein the first warp yarns cross the second warp yarns in the transition portion.

### TECHNICAL FIELD

The invention relates to a fibrous preform having a sudden thickness variation, for example a fibrous preform intended to form the fiber reinforcement of a turbomachine component, and in particular of a blade with integrated root.

### PRIOR ART

In order to obtain lightweight turbomachine components with excellent thermomechanical properties, components made of composite materials are produced in a well-known manner, that is to say components comprising a fiber reinforcement densified by a matrix. The use of composite materials contributes to optimizing the performance of the turbomachine, in particular by reducing the overall mass of the turbomachine, which contributes to a reduction in fuel consumption and therefore to a significant reduction in pollutant emissions.

Furthermore, ceramic matrix composite materials can withstand temperatures ranging from 600 °C to 1400 °C. Due to their better resistance to high temperatures, ceramic matrix composite materials require less cooling. Since this cooling conventionally comes from a draw in the compressor, which impacts the efficiency of the turbomachine, composite materials therefore allow to further improve engine efficiency and further reduce fuel consumption.

In particular, it is known to produce the fibrous preform of the component by three-dimensional weaving on a jacquard-type loom, said preform then being shaped to obtain a fibrous blank of the component to be produced, which will be densified by the matrix.

For the production of components having sudden or significant variations in thickness, such as for example a blade having a thick root portion and a thinner aerodynamic profile portion, several methods are known from the prior art.

A first method consists in using a jacquard-type loom compatible with large thicknesses of preform and capable of handling a very large number of yarns. The large thickness part of the preform to be produced is thus produced with a very large number of yarns, then numerous layer exits are carried out in order to remove a large number of yarns from the weaving in the small thickness part of the preform to be produced. However, this expensive method requires the use of non-standard looms, in particular having a jacquard head and a harness of a much larger size than those conventionally used for these types of components. Furthermore, the large number of yarns to be handled and the layer exits to be carried out greatly complicate the weaving and increase the risks of defects in the preform obtained.

A second method consists in using thicker weft yarns in the portions of the preform to be thickened, or even assemblies of yarns, for example in the form of a braid. Such a method is described in particular in documents WO 2021/005286 A1 and WO 2010/061140 A1. However, the use of such thick fibrous elements causes unwanted local increases in the fiber volume ratio and promotes densification defects in the final component by hindering the infiltration of gas, powder or resin into the preform. The use of this method for producing a preform must therefore be limited so as not to harm the mechanical characteristics of the final densified component.

Finally, a third method consists in making changes in weave pattern between the different portions of the fibrous preform to produce different thicknesses. Such a method is described in particular in document EP 1 526 285 A1. However, this method does not allow sudden variations in thickness to be made between two portions of the fibrous preform without generating an irregular fiber volume ratio and weaving defects in the short transition zone between the two portions of very different thicknesses having distinct weaves.

Furthermore, in all the methods described above, the curvature that the rigid surface fibers must adopt at the location of a large thickness variation is too great. Thus, in the final component obtained, the fibers do not adequately fill the areas with a large thickness variation at the surface of the component, which are then essentially made up of matrix and insufficiently reinforced.

### DISCLOSURE OF THE INVENTION

The main purpose of the present invention is therefore to overcome the aforementioned disadvantages by proposing a method for weaving a fibrous preform having a sudden and significant thickness variation.

To this end, the invention proposes a fibrous preform produced in a single piece by three-dimensional weaving comprising a plurality of warp yarns extending in a longitudinal direction and a plurality of weft yarns extending in a transverse direction, said preform comprising in the longitudinal direction first and second portions connected by a transition portion, the first portion being thicker than the second portion in a thickness direction perpendicular to the transverse and longitudinal directions, each portion comprising, in the thickness direction, a core part provided between two surface parts, the core part of the first portion comprising a plurality of first warp yarns and a plurality of second warp yarns, said preform being characterized in that the first warp yarns cross the second warp yarns in the transition portion.

Thus, the creation of warp yarn crossings at the core of the fibrous preform in the transition portion allows to increase the maximum achievable thickness of the fibrous preform without modifying the size or elements of the loom. This technique also allows to increase the maximum achievable thickness of the fibrous preform without increasing the number of layers of yarns handled during weaving and without carrying out complex weaving operations such as layer exits. The present invention therefore allows to produce a fibrous preform having significant thickness variations over a very short distance, while limiting variations in the fiber content.

Moreover, by making the crossings of the yarns in the transition portion, the expansion inside the transition portion is increased, thus allowing the fibers located on the surface of the transition portion to have the desired trajectory. Therefore, in the final component obtained by densification of the fibrous preform, the transition portion of the final component between the thick portion and the thin portion is suitably reinforced by the fibers, including at its surface.

In particular, there is at least one plane of the fibrous preform perpendicular to the transverse direction in which the first warp yarns cross the second warp yarns in the transition portion. Preferably, the first warp yarns cross the second warp yarns in the core part of the transition portion, in order to preserve the surface layers of the fibrous preform and to maintain a satisfactory surface condition.

According to a particular embodiment of the invention, the core part of the first portion has a weave pattern different from the weave pattern of the core part of the second portion.

The use of different weave patterns between the two portions further increases the thickness variation in the fibrous preform, with the crossings in the transition portion ensuring a satisfactory transition between the two weave patterns.

According to another particular embodiment of the invention, the core part of the first portion comprises weft yarns having a larger section than the section of the weft yarns of the core part of the second portion.

The use of weft yarns having a large section, or more generally of expansion elements having a large section, allows to further increase the thickness variation in the fibrous preform, the crossings in the transition portion ensuring a satisfactory transition between the weft yarns of large section and those of smaller section.

According to another particular embodiment of the invention, the surface parts of the first portion, the transition portion and the second portion have the same weave pattern.

Thus, the fibrous preform, and by extension the component obtained by densification of the fibrous preform, has a controlled and constant surface state throughout its length.

According to another particular embodiment of the invention, the first portion, the transition portion and the second portion comprise the same number of warp yarns in each plane of the preform perpendicular to the transverse direction.

This makes it easier to weave the fibrous preform by maintaining a constant number of warp yarns, and promotes a relatively variable fiber volume ratio in the fibrous preform.

According to a particular embodiment of the invention, each first warp yarn crosses each of the second warp yarns in the transition portion in said at least one plane of the fibrous preform perpendicular to the transverse direction. Preferably, each first warp yarn crosses each of the second warp yarns once in the transition portion in said at least one plane of the fibrous preform perpendicular to the transverse direction.

Conversely, each second warp yarn may cross each of the first warp yarns in the transition portion in said at least one plane of the fibrous preform perpendicular to the transverse direction. Preferably, each second warp yarn may cross each of the first warp yarns once in the transition portion in said at least one plane of the fibrous preform perpendicular to the transverse direction.

In particular, each first warp yarn crosses, preferably only once, each of the second warp yarns in the transition portion in all planes of the fibrous preform perpendicular to the transverse direction. Conversely, each second warp yarn crosses, preferably only once, each of the first warp yarns in the transition portion in all planes of the fibrous preform perpendicular to the transverse direction.

According to a particular embodiment of the invention, each first warp yarn crossing a second warp yarn in the transition portion crosses in the transition portion all the second warp yarns crossing first warp yarns in said at least one plane of the fibrous preform perpendicular to the transverse direction. Conversely, each second warp yarn crossing a first warp yarn in the transition portion may cross in the transition portion all the first warp yarns crossing second warp yarns in said at least one plane of the fibrous preform perpendicular to the transverse direction. These characteristics may be achieved in all planes of the fibrous preform perpendicular to the transverse direction.

According to another particular embodiment of the invention, the core part of the first portion comprises a first and a second core part along the thickness direction, the first core part comprising the first warp yarns and the second core part comprising the second warp yarns.

The first core part and the second core part may be distinct, and may be adjacent. Thus, crossing the wires in the transition portion ensures better expansion.

According to another particular embodiment of the invention, the preform comprises at least one plane perpendicular to the transverse direction in which the transition portion comprises a plurality of successive weft columns Tₙ with n comprised between 1 and N, the weft column T₁ being the weft column adjacent to the first portion of the preform, N corresponding to the number of first warp yarns of the first portion crossing second warp yarns of the first portion, so that in the weft column Tₙ, n first warp yarns of the first portion cross n second warp yarns of the first portion.

The yarns are thus crossed regularly, allowing optimal expansion while limiting the variation in the volume rate of fibers.

The invention also relates to a process for manufacturing a fibrous blank for a component made of composite material, the process comprising the following steps:
producing a fibrous preform according to the invention,
shaping the fibrous preform so as to obtain a fibrous blank comprising an adjacent sacrificial portion and a useful portion, the sacrificial portion being formed at least by the first portion of the fibrous preform and the useful portion being formed by the second portion of the fibrous preform and at least part of the transition portion of the fibrous preform.

Furthermore, the invention relates to a process for manufacturing a component made of composite material comprising at least the following steps:
producing a fibrous blank in accordance with the process for manufacturing a fibrous blank according to the invention,
introducing a composition comprising at least one precursor of a matrix material into the fibrous blank,
transforming the composition into a matrix so as to obtain an intermediate component made of composite material comprising a fibrous reinforcement densified by a matrix, the intermediate component comprising a sacrificial portion whose fibrous reinforcement is formed by the sacrificial portion of the fibrous blank,
removing the sacrificial portion of the intermediate component to obtain the final component.

According to a preferred embodiment of the invention, the invention relates to a process for manufacturing a component made of ceramic matrix composite material comprising the following steps:
producing a fibrous blank in accordance with the process for manufacturing a fibrous blank according to the invention,
consolidating the fibrous blank by chemical vapor infiltration,
impregnating the consolidated fibrous blank with a suspension comprising ceramic particles, then
infiltrating liquid silicon into the fibrous blank so as to obtain an intermediate component made of ceramic matrix composite material comprising a fiber reinforcement densified by a ceramic matrix, the intermediate component comprising a sacrificial portion whose fiber reinforcement is formed by the sacrificial portion of the fibrous blank,
removing the sacrificial portion of the intermediate component to obtain the final component.

Finally, the invention relates to a use of the process for manufacturing a component made of a composite material according to the invention for the manufacture of a turbomachine blade made of a composite material.

### BRIEF DESCRIPTION OF THE DRAWINGS

FIG. 1 is a schematic perspective view of a fibrous preform according to the invention.

FIG. 2 is a schematic representation of a weaving plan belonging to the fibrous preform according to the invention.

FIG. 3 is an exploded perspective schematic view showing a forming tool in accordance with one embodiment of the invention and the placement of the fibrous preform of FIGS. 1 and 2 therein.

FIG. 4 is a schematic perspective view of a fibrous blank according to the invention obtained by shaping the fibrous preform of FIGS. 1 and 2, and comprising a sacrificial portion.

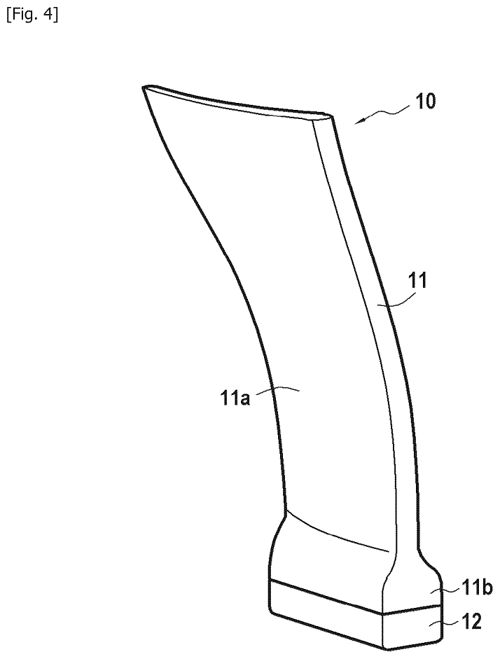

FIG. 5 is a schematic perspective view showing an operation of injecting a liquid matrix precursor composition into the fibrous blank of FIG. 5.

FIG. 6 is a schematic perspective view of a component made of composite material obtained after the injection operation of FIG. 6 with the removal of the sacrificial portion.

### DESCRIPTION OF THE EMBODIMENTS

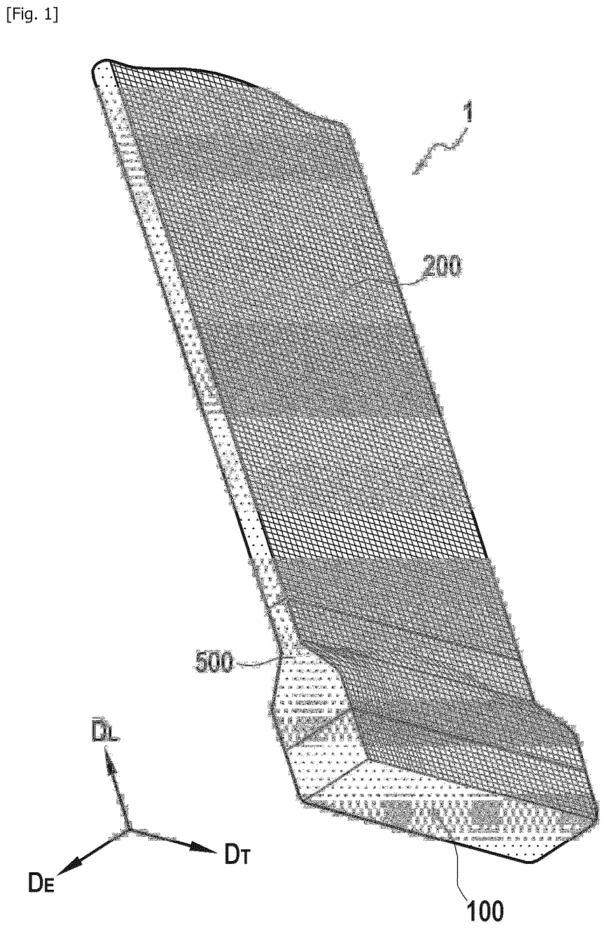

FIGS. 1 to 3 illustrate a fibrous preform 1 according to the invention produced by three-dimensional weaving between a plurality of layers of warp yarns and a plurality of layers of weft yarns. “Three-dimensional weaving” or “3D weaving” means here a weaving method by which at least some of the warp yarns bind weft yarns on several weft layers. A reversal of roles between warp and weft is possible. The fibrous preform 1 is preferably produced using a jacquard type loom. Such a weaving loom is for example described in document FR 3 047 744 A1.

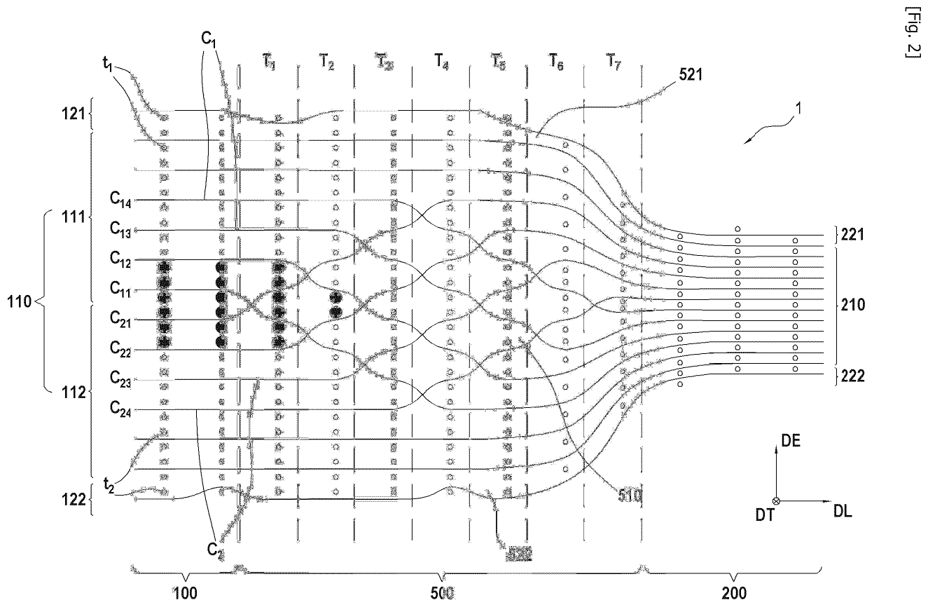

As illustrated in FIG. 1, the fibrous preform 1 extends in the warp direction along a longitudinal direction D_{L} and in the weft direction along a transverse direction D_{T}. The fibrous preform 1 extends in thickness along a thickness direction D_{E} perpendicular to the longitudinal directions D_{L} and transverse directions D_{T}. FIG. 2 shows a schematic weaving plan of the fibrous preform 1 perpendicular to the transverse direction D_{T}.

The fibrous preform 1 comprises, along the longitudinal direction D_{L}, at least a first portion 100 and a second portion 200, separated by a transition portion 500. The first portion 100 is thicker than the second portion 200, that is to say that its dimension along the thickness direction D_{E} is greater than the dimension of the second portion 200 along the thickness direction D_{E}. The first portion 100 and the transition portion 500 are adjacent along the longitudinal direction D_{L}. The second portion 200 and the transition portion 500 are adjacent along the longitudinal direction D_{L}. Preferably, the first portion 100 and the second portion 200 extend over the entire thickness of the fibrous preform 1 along the thickness direction D_{E}, and over the entire width of the fibrous preform 1 along the transverse direction D_{T}.

In the example illustrated in FIGS. 1 and 2, the fibrous preform 1 comprises only the first portion 100, the transition portion 500 and the second portion 200. It is of course not departing from the scope of the invention if the fibrous preform comprises additional portions in the longitudinal direction D_{L}.

The first portion 100 of the fibrous preform 1 comprises a core part 110 and two surface parts 121 and 122. The core part 110 of the first portion 100 of the fibrous preform 1 extends in the thickness direction D_{E} between the first surface part 121 of the first portion 100 and the second surface part 122 of the first portion 100. The first surface part 121 and the second surface part 122 of the first portion 100 may join on either side of the core part 110 in the transverse direction D_{T}. In this configuration, the first and second surface parts 121 and 122 form an overall surface part of the first portion 100 surrounding the core part 110 of said first portion 100.

The second portion 200 of the fibrous preform 1 comprises a core part 210 and two surface parts 221 and 222. The core part 210 of the second portion 200 of the fibrous preform 1 extends in the thickness direction D_{E} between the first surface part 221 of the second portion 200 and the second surface part 222 of the second portion 200. The first surface part 221 and the second surface part 222 of the second portion 200 may join on either side of the core part 210 in the transverse direction D_{T}. In this configuration, the first and second surface parts 221 and 222 form an overall surface part of the second portion 200 surrounding the core part 210 of said second portion 200.

The transition portion 500 of the fibrous preform 1 comprises a core part 510 and two surface parts 521 and 522. The core part 510 of the transition portion 500 of the fibrous preform 1 extends in the thickness direction D_{E} between the first surface part 521 of the transition portion 500 and the second surface part 522 of the transition portion 500. The first surface part 521 and the second surface part 522 of the transition portion 500 may join on either side of the core part 510 in the transverse direction D_{T}. In this configuration, the first and second surface parts 521 and 522 form an overall surface part of the transition portion 500 surrounding the core part 510 of said transition portion 500.

Preferably, the first surface part 521 of the transition portion 500 is located in the extension of the first surface part 121 of the first portion 100 and in the extension of the first surface part 221 of the second portion 200. Preferably, the second surface part 522 of the transition portion 500 is located in the extension of the second surface part 122 of the first portion 100 and in the extension of the second surface part 222 of the second portion 200. Therefore, preferably, the core part 510 of the transition portion 500 is located in the extension of the core part 110 of the first portion 100 and in the extension of the core part 210 of the second portion 200.

The core part 110 of the first portion 100 comprises a first core part 111 and a second core part 112. The first core part 111 extends along the thickness direction D_{E} between the first surface part 121 and the second core part 112. The second core part 112 extends along the thickness direction D_{E} between the first core part 111 and the second surface part 122.

First warp yarns c₁ bind together the weft yarns t₁ of the first core part 111 of the first portion 100 of the preform 10. Second warp yarns c₂ bind together the weft yarns t₂ of the second core part 112. The first and second warp yarns c₁ and c₂ then bind together the weft yarns t₅ of the core part 510 of the transition portion 500. Preferably, all the warp yarns of the first core part 111 of the first portion 100 of the preform 10 are first warp yarns c₁ and all the warp yarns of the second core part 112 of the first portion 100 of the preform 1 are second warp yarns c₂.

In the example illustrated in FIG. 2, a part of the first warp yarns c₁ from the first core part 111 of the first portion 100 crosses a part of the second warp yarns c₂ from the second core part 112 of the first portion 100 in the core part 510 of the transition portion 500. It is of course not outside the scope of the invention if all the first warp yarns c₁ from the first core part 111 of the first portion 100 crosses all the second warp yarns c₂ from the second core part 112 of the first portion 100 in the core part 510 of the transition portion 500.

The transition portion 500 comprises a plurality of adjacent frame columns T₁, T₂, . . . T₇ oriented along the thickness direction D_{E}. In particular, the transition portion 500 extends along the longitudinal direction D_{L} between, on the one hand, the first frame column T₁ and the last frame column T₇. The first weft column T₁ of the transition portion 500 is defined as the weft column comprising at least one crossing between a first warp yarn c₁ and a second warp yarn c₂ closest to the first portion 100 of the fibrous preform 1. The last weft column T₇ of the transition portion 500 is defined as the weft column comprising at least one crossing between a first warp yarn c₁ and a second warp yarn c₂ closest to the second portion 200 of the fibrous preform 1. Preferably, the first weft column T₁ of the transition portion 500 is the weft column of the transition portion 500 adjacent to the first portion 100 of the preform 10. Preferably, the last weft column T₇ of the transition portion 500 is the weft column of the transition portion 500 adjacent to the second portion 200 of the preform 10.

Preferably, as illustrated in FIG. 2, in each plane of the preform 1 perpendicular to the transverse direction D_{T}, there are no crossings between the warp yarns in the first portion 100, and there are no crossings between the warp yarns in the second portion 200. Preferably, there are also no crossings between or with warp yarns originating from a surface part 121, 122, 521, 522, 221, 222 of the first portion 100, the transition portion 500 or the second portion 200 of the fibrous preform 1.

The crossings between warp yarns from the first portion 100 of the fibrous preform 1 in the transition portion 500 may be present in all the planes of the fibrous preform 1 perpendicular to the transverse direction D_{T}, or only in a part of the planes of the fibrous preform 1 perpendicular to the transverse direction D_{T}.

Preferably, as illustrated in FIG. 2, each first warp yarn c₁ crossing a second warp yarn c₂ crosses each second warp yarn c₂ once. Conversely, each second warp yarn c₂ crossing a first warp yarn c₁ crosses each first warp yarn ci once.

Preferably, as illustrated in FIG. 2, the crossing of the first warp yarns c₁ from the first core part 111 of the first portion 100 with the second warp yarns c₂ from the second core part 112 of the first portion 100 is done in a regular manner, by first crossing the first warp yarns c₁ closest to the second core part 112 and the second warp yarns c₂ closest to the first core part 111, then by progressively crossing warp yarns c₁ and c₂ that are increasingly distant. Thus, in the first weft column T₁ closest to the first portion 100 belonging to the transition portion 500, a single first warp yarn c₁₁ from the first core part 111 of the first portion 100 crosses a single second warp yarn c₂₁ from the second core part 112 of the first portion 100: the first warp yarn c₁₁ closest to the second core part 112 in the first portion 100 crosses the second warp yarn c₂₁ closest to the first core part 111 in the first portion 100. In the second weft column T₂ closest to the first portion 100 belonging to the transition portion 500, only two first warp yarns c₁₁, c₁₂ from the first core part 111 of the first portion 100 cross only two second warp yarns c₂₁, c₂₂ from the second core part 112 of the first portion 100: the first warp yarn c₁₁ crosses the second warp yarn c₂₂ and the first warp yarn c₁₂ crosses the second warp yarn c₂₁. In the third weft column T₃ closest to the first portion 100 belonging to the transition portion 500, only three first warp yarns c₁₁, c₁₂, c₁₃ from the first core part 111 of the first portion 100 cross only three second warp yarns c₂₁, c₂₂, c₂₃ from the second core part 112 of the first portion 100: the first warp yarn c₁₁ crosses the second warp yarn c₂₃, the first warp yarn c₁₂ crosses the second warp yarn c₂₂ and the first warp yarn c₁₃ crosses the second warp yarn c₂₁.

In general, Tₙ denotes the n-th weft column of the transition portion 500 closest to the first portion 100 for n comprised between 1 and N included, N being the number of first yarns c₁₁, c₁₂, c₁₃, c₁₄ crossing second yarns c₂₁, c₂₂, c₂₃, c₂₄ in the transition portion 500 or N being the number of second yarns c₂₁, c₂₂, c₂₃, c₂₄ crossing first yarns c₁₁, c₁₂, c₁₃, c₁₄ in the transition portion 500. In the example illustrated in FIG. 2, the number N has the value 4. Thus, in each column Tₙ, n first warp yarns from the first core part 111 of the first portion 100 cross n second warp yarns from the second core part 112 of the first portion 100. In the example illustrated in FIG. 2, for n=N, in the fourth column T₄ there are 4 first warp yarns c₁₁, c₁₂, c₁₃, c₁₄ from the first core part 111 of the first portion 100 which cross 4 second warp yarns c₂₁, c₂₂, c₂₃, c₂₄ from the second core part 112 of the first portion 100.

Furthermore, in each column Tₙ, the first warp yarn c_{1 n-i} crosses the second warp yarn c_{2 i+1} for i comprised between 0 and n−1 included. Thus, in the example illustrated in FIG. 2, in column T₂, that is to say n=2, the increment i=0 clearly indicates that the first warp yarn c_{1 2-0}, that is to say c₁₂, crosses the second warp yarn c_{2 0+1}, that is to say c₂₁, and the increment i=1 clearly indicates that the first warp yarn c_{1 2-1}, that is to say c₁₁, crosses the second warp yarn c_{2 1+1}, that is to say c₂₂.

The fibrous preform 1 according to the invention may further comprise expansion elements in the core part 110 of the first portion 100 of the preform 1. These expansion elements are preferably weft yarns with a high count, that is to say having a high thickness and section. Thus, part of the weft yarns of the core part 110 of the first portion 100 have a larger sectional size than the weft yarns of the surface parts 121 and 122 of the first portion 100 and have a larger sectional size than the weft yarns of the core part 210 of the second portion 200. Thus, the weft yarns located in the surface parts 121 and 122 of the first portion 100 may thus have a first sectional size, that is to say a first thickness, and the weft yarns located in the center of the core part 110 of the first portion 100 may have a second sectional size, that is to say a second thickness. In the example illustrated in FIG. 2, the weft yarns of the core part 110 furthest from the center of said core part 110 also have the first sectional size, that is to say the first thickness.

The weft yarns may have different section sizes, for example so as to obtain progressive weft yarn section sizes in the thickness of the first portion 100. Intermediate weft yarns may be present between the weft yarns having the first section size, that is to say the first thickness, and the weft yarns having the second section size, that is to say the second thickness, said intermediate weft yarns having an intermediate section size between the first and second sections, that is to say an intermediate thickness between the first and second sections. For example, the second section size is two to ten times greater than the first section size.

The expansion elements, or the weft yarns corresponding to the expansion elements, can be in the form of an assembly of filaments or in the form of a braid.

The presence of such expansion elements in the first portion 100 may allow to increase the thickness of the transition portion 500. Expansion elements may also be present in the transition portion 500, in the part of the transition portion 500 directly adjacent to the first portion 100. Preferably, the expansion elements of the first portion 100 and of the transition portion 500 are not intended to be part of the final component made of composite material, but are only means for increasing the thickness and expansion of the fibrous preform.

As illustrated in FIG. 2, the core part 110 of the first portion 100 has a first weave pattern and the core part 210 of the second portion 200 has a second weave pattern, the second weave pattern preferably being different from the first weave pattern. In order to increase the expansion, and therefore the thickness, of the first portion 100 relative to the second portion 200, a first weave is chosen so that it allows for greater expansion than the second weave. Preferably, the first weave and the second weave are chosen so as to allow a similar fiber volume ratio in the first and second portions 100 and 200.

In order to further increase the abundance of the core part 110 of the first portion 100, it is possible to produce weft doublings, as illustrated in FIG. 2. Weft doubling means that in a plane of the fibrous preform 1 perpendicular to the transverse direction D_{T}, the warp yarns c₁ and c₂ of the core part 110 of the first portion 100 bind the weft yarns in pairs, that is to say that the pairs of weft yarns are not separated by a warp yarn in said plane perpendicular to the transverse direction D_{T}.

Preferably, the core part 110 of the first portion 100 or the core part 210 of the second portion 200 is produced by interlock type weaving, in order to obtain mechanical properties that are as homogeneous as possible within said core part 110 or 210 and to promote homogeneous densification by the matrix. “Interlock weave” means here a three-dimensional weave pattern in which each warp layer binds together several weft layers with all the yarns in the same warp column having the same movement in the plane of the weave.

If, in a plane of the fibrous preform 1 perpendicular to the transverse direction D_{T}, warp yarns from the core part 110 of the first portion 100 do not cross other warp yarns in the transition portion 500, said warp yarns may have a weave pattern in the transition portion 500 identical to the weave pattern of the core part 110 of the first portion 100.

As illustrated in FIG. 2, the surface parts 121 and 122 of the first portion 100, the surface parts 521 and 522 of the transition portion and/or the surface parts 221 and 222 of the second portion 200 are preferably made by weaving with a plain, satin or twill weave in order to limit surface irregularities, a satin weave also providing a smooth surface appearance. Thus, after densification of the fibrous preform 1, the use of these types of weave promotes obtaining a surface state free of significant irregularities, that is to say a good finishing state to avoid or limit finishing operations by machining or to avoid the formation of resin clumps in the case of resin matrix composites. Preferably and as illustrated in FIG. 2, the first surface part 121 of the first portion 100, the first surface part 521 of the transition portion 500 and the first surface part 221 of the second portion 200 have an identical and continuous weave pattern along the longitudinal direction D_{L}, in order to ensure a controlled surface condition over the entire length of the final densified component obtained from the preform 1.

Therefore, it is possible according to the invention to combine the methods of the prior art, which relate to the addition of weft yarns of high thickness and the use of different weave patterns, with the method of the invention which describes the crossing of warp yarns within the transition portion. Tests have been carried out to study the combination of the methods described previously with the new method proposed in the present invention, with the purpose of obtaining high thickness parts in a fibrous preform by means of a standard weaving loom.

With the standard loom used in these tests, without resorting to the two methods of the prior art and the crossing method of the invention, it is possible to produce fibrous preforms having a maximum thickness of 7 mm. According to the tests carried out, using a change of weave alone, it is only possible to produce fibrous preforms having a thickness of 13 mm. By combining the change of weave and the crossing method of the invention, it is possible to increase the thickness obtained to 14 mm, while maintaining a satisfactory fiber volume ratio. Moreover, by combining the change of weave with weft yarns of significant thickness, it is only possible to produce fibrous preforms having a thickness of 20 mm. By combining the change of weave, the thick weft yarns and the crossing method of the invention, it is possible to exceed 20 mm of thickness of the preform, while maintaining a satisfactory fiber volume ratio. The combination of the three methods provided by the invention can therefore allow to locally triple the thickness of the fibrous preform.

Preferably, the fibrous preform 1 according to the invention does not comprise a layer exit, which means that the number of layers of warp yarns is identical in the first portion 100, in the transition portion 500 and in the second portion 200. In particular, the number of layers of warp yarns is preferably identical in the core part 110 of the first portion 100, in the core part 510 of the transition portion 500 and in the core part 210 of the second portion 200 of the fibrous preform 1.

Preferably, the fibrous preform 1 corresponds to a “dry” fibrous texture, that is to say not impregnated with a resin or the like. The fibrous preform 100 may include a plurality of yarns or filaments of various types, in particular ceramic or carbon yarns or a mixture of such yarns. Preferably, the fibrous preform 100 may be made from silicon carbide fibers. Generally, the fibrous preform 100 may also be made from fibers made of the following materials: alumina, mullite, silica, an aluminosilicate, a borosilicate, carbon, or a mixture of several of these materials.

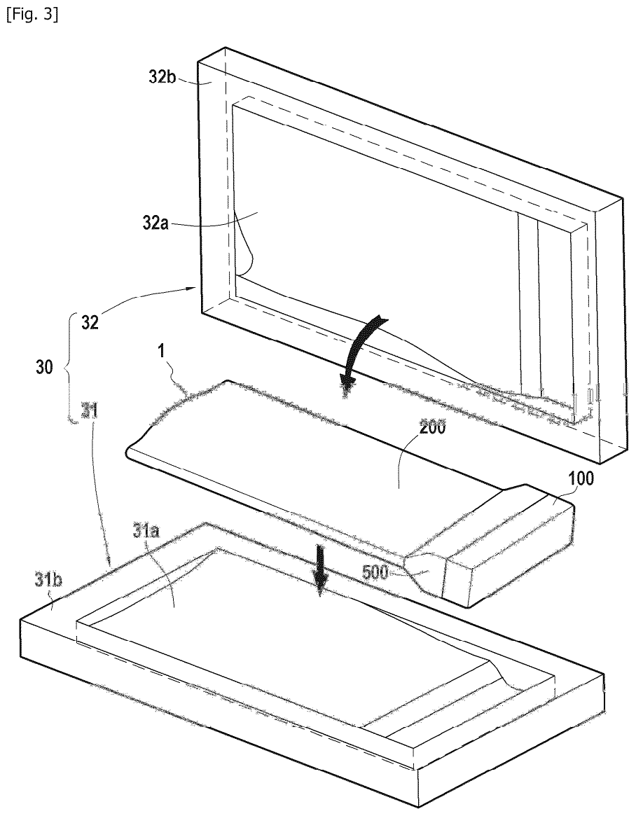

Preferably, the fibrous preform 1 is shaped by compaction to form a fibrous blank ready to be densified. For this purpose, the fibrous preform 1 is placed in a forming tool 30 which, as illustrated in FIG. 3, comprises a first shell 31 comprising in its center a first imprint 31a corresponding in part to the shape and dimensions of the component to be produced, the imprint 31a being surrounded by a first contact plane 31b.

The tool 30 also comprises a second shell 32 comprising in its center a second imprint 32a corresponding in part to the shape and dimensions of the component to be produced, the second imprint 32a being surrounded by a second contact plane 32b intended to cooperate with the first contact plane 31a of the first shell 31.

The fibrous preform 1 is first positioned in the imprint 31a of the first shell 31, the second shell 32 then being placed on the first shell 31 in order to close the forming tool 30. Once the tool 30 is closed, the first and second shells are in a position called the “assembly position”, that is to say a position in which the first and second imprints 31a, 32a are placed opposite each other while the first and second contact planes 31b and 32b are also opposite each other. In this configuration, the first and second imprints 31a, 32a together define an internal volume having the shape of the component to be produced and in which the fibrous preform 1 is placed.

In the case of the manufacture of a turbomachine blade, the imprint 31a is intended to form the pressure side of the fiber blade blank while the imprint 32a is intended to form the suction side of the blade blank. Thanks to the presence of the first portion 100 of the fibrous preform 10 and the crossings of wires described previously, the transition portion has a sufficient thickness to fill the enlarged part of the internal volume of the tool 30 intended to shape the blade root.

Then, the forming tool 30 with the fibrous preform 1 therein is placed in a compacting press. The press comprises a lower part on which the first shell 31 of the forming tool 30 rests and an upper part placed on the second shell 32 of the forming tool 30.

The forming tool 30 is then subjected to the application of a compacting pressure applied by the press. The application of the pressure causes the first and second shells 31 and 32 to come together until the first and second contact planes 31b and 32b meet, which allows both to compact the fibrous preform 1 according to a determined compaction rate in order to obtain a fiber rate that is also determined and to shape the fibrous preform according to the profile of the blade to be manufactured. A fibrous blank 10 is then obtained, said blank having the shape of the component to be produced and including a sacrificial portion 12 corresponding at least to the first portion 100 of the fibrous preform 1 and an adjacent useful portion 11 corresponding to the second portion 200 of the fibrous preform 1 and to at least a part of the transition portion 500 of the fibrous preform 1. The transition portion 500 of the preform 1 may be entirely included in the useful portion 11 of the blank 10. A part of the transition portion 500 of the preform 1 may be included in the sacrificial portion 12 of the blank 10. Preferably, the useful portion 11 does not comprise weft yarns having a large section, that is to say having a significant thickness. In particular, preferably, the useful portion 11 does not comprise weft yarns having a section size more than twice the maximum section size of the weft yarns of the second portion 200 of the fibrous preform 1.

In the case of the manufacture of a turbomachine blade, the useful portion 11 of the fibrous blank 10 comprises an aerodynamic profile part 11a intended to form the fiber reinforcement of the aerodynamic profile of the blade, and comprises a root part 11b intended to form the fiber reinforcement of the root of the blade.

The densification of the fibrous blank 10 is then carried out. The densification of the fibrous blank 10 intended to form the fibrous reinforcement of the component to be manufactured consists in filling the porosity of the blank, in all or part of its volume, with the material constituting the matrix.

According to a first embodiment of the invention, the fibrous blank 10 is preferably densified by a ceramic matrix, in order to obtain a component made of ceramic matrix composite material, called “CMC”. Indeed, ceramic matrix composite materials have interesting mechanical properties at high temperature, which is particularly useful for the manufacture of turbomachine blades.

Thus, the fibrous blank can be consolidated or densified in a well-known manner by gaseous means by chemical vapor infiltration of the matrix, called “CVI”. The fibrous blank corresponding to the fiber reinforcement of the blade to be produced is placed in a furnace into which a reaction gas phase is admitted. The pressure and temperature prevailing in the furnace and the composition of the gas phase are chosen so as to allow the diffusion of the gas phase within the porosity of the blank to form at least part of the matrix by deposition, at the core of the material in contact with the fibers, of a solid material resulting from a decomposition of a constituent of the gas phase or a reaction between several constituents, unlike the pressure and temperature conditions specific to CVD (“Chemical Vapor Deposition”) processes which lead exclusively to a deposition on the surface of the material. The formation of a SiC matrix can be obtained with methyltrichlorosilane (MTS) giving SiC by decomposition of the MTS.

A densification combining gas and liquid routes can be used in a well-known manner to facilitate implementation and limit costs and manufacturing cycles while obtaining satisfactory characteristics for the intended use. In this configuration, consolidation of the fibrous blank is carried out by gas as described previously, then impregnation of the fibrous blank is carried out with a slurry (“slurry cast”) containing for example SiC particles and organic binders, followed by infiltration with liquid silicon (“melt infiltration”).

The consolidation of the fibrous blank can be carried out in a manner known per se using liquid (LC). The liquid process consists in impregnating the blank with a liquid composition containing a precursor of the ceramic matrix material. The blank is placed in a mold that can be sealed with a housing having the shape of the final molded blade. Then, the mold is closed and the liquid ceramic matrix precursor is injected into the entire housing to impregnate the entire fibrous part of the blank.

The transformation of the precursor into a matrix, namely its polymerization, is carried out by heat treatment, generally by heating the mold, after elimination of any solvent and crosslinking of the polymer, the blank always being maintained in the mold having a shape corresponding to that of the component to be produced.

In the case of carbon or ceramic matrix formation, the heat treatment consists in pyrolyzing the precursor to transform the matrix into a carbon or ceramic matrix depending on the precursor used and the pyrolysis conditions. For example, liquid ceramic precursors, particularly SiC, can be polycarbosilane (PCS) or polytitanocarbosilane (PTCS) or polysilazane (PSZ) resins, while liquid carbon precursors can be resins with a relatively high coke content, such as phenolic resins. Several consecutive cycles, from impregnation to heat treatment, can be carried out to achieve the desired degree of densification.

According to a second embodiment of the invention, the fibrous blank 10 can be densified by an organic matrix, in order to obtain a component made of organic matrix composite material, called “CMO”.

The densification of the fibrous blank can then be carried out by the well-known transfer molding process called RTM (“Resin Transfer Molding”). According to the RTM process, the fibrous blank is placed in a mold having the external shape of the component to be produced. A resin is injected into the internal space of the mold which contains the fibrous blank. A pressure gradient is generally established in this internal space between the place where the resin is injected and the resin discharge orifices in order to control and optimize the impregnation of the blank by the resin.

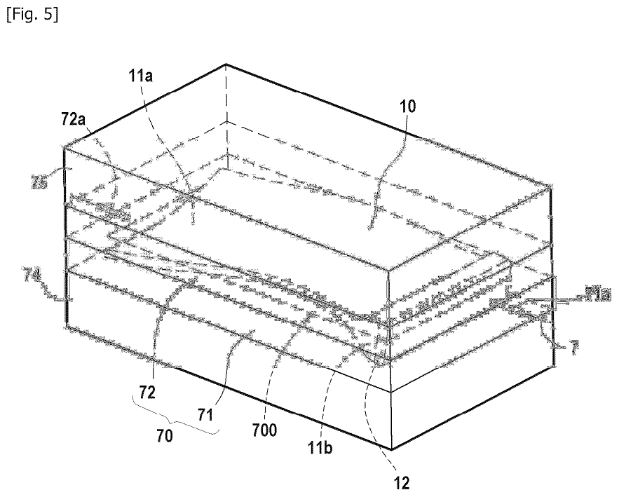

The injection of a liquid matrix precursor composition into the fibrous preform and its transformation into a matrix are carried out in an injection tool 70 shown in FIG. 5. As for the forming tool 30, the injection tool 70 comprises a first shell 71 comprising in its center a first imprint corresponding in part to the shape and dimensions of the component to be produced and a second shell 72 comprising in its center a second imprint corresponding in part to the shape and dimensions of the component to be produced. Once the tool 70 is closed, the first and second imprints respectively of the first and second shells 71 and 72 together define an internal volume 700 having the shape of the component to be produced and in which the fibrous blank 10 is placed.

The tool 70 further comprises means for carrying out the injection of a liquid matrix precursor and the transformation of this precursor into a matrix. More specifically, in the example described here, the first shell 71 of the tool 70 comprises an injection port 71a intended to allow the injection of a liquid matrix precursor composition 7 into the fibrous blank while the second shell comprises an evacuation port 72a intended to cooperate with a pumping system for vacuuming the tool and drawing air during injection. The injection tool 70 also comprises a lower part 74 and an upper part 75 between which the first and second shells 71 and 72 are placed, the lower part 74 and the upper part 75 being equipped with heating means (not shown in FIG. 5).

Once the tool 70 is closed, the blade is molded by impregnating the blank 10 with, for example, a thermosetting resin that is polymerized by heat treatment. For this purpose, the well-known injection or transfer molding process known as RTM (“Resin Transfer Molding”) is used. In accordance with the RTM process, a resin 7, for example a thermosetting resin, is injected via the injection port 71a of the first shell 71 into the internal volume 700 occupied by the blank 10. The port 723 of the second shell 720 is connected to a discharge conduit maintained under pressure (not shown in FIG. 5). This configuration allows the establishment of a pressure gradient between the lower part of the blank 10 where the resin is injected and the upper part of the blank located near the port 72a. In this way, the resin 7 injected substantially at the lower part of the blank will gradually impregnate the entire blank by circulating therein up to the evacuation port 72a through which the excess is evacuated. Of course, the first and second shells 71 and 72 of the tool 70 may respectively comprise several injection ports and several evacuation ports.

The resin used can, for example, be an epoxy resin with a temperature class 180 °C (maximum temperature supported without loss of characteristics). Resins suitable for RTM processes are well known. They preferably have a low viscosity to facilitate their injection into the fibers. The choice of temperature class and/or the chemical nature of the resin is determined according to the thermomechanical stresses to which the component must be subjected. Once the resin has been injected throughout the reinforcement, it is polymerized by heat treatment in accordance with the RTM process. After injection and polymerization, the component is demolded.

The densification processes described above allow to produce, from the fibrous preform of the invention, mainly components made of organic matrix composite (OMC), carbon matrix (C/C) and ceramic matrix (CMC) material. The component made of composite materials obtained by the preceding densification processes can optionally undergo a post-curing cycle to improve their thermomechanical characteristics. Finally, the component can be trimmed to remove any excess resin and chamfers can be machined.

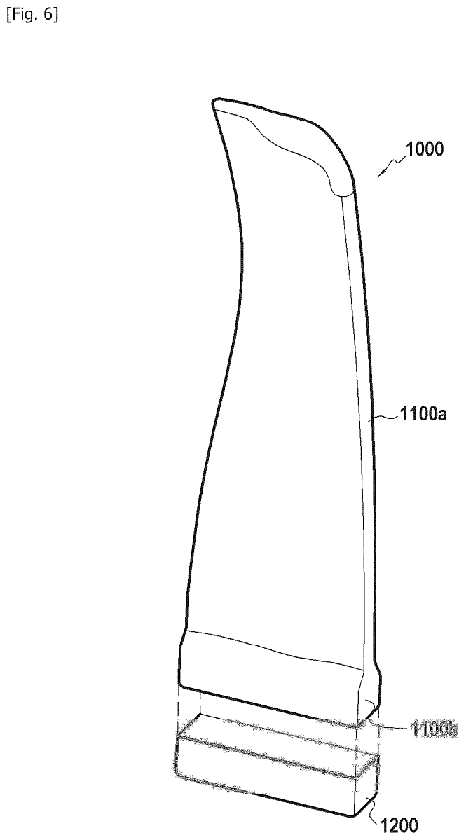

As illustrated in FIG. 6, a component 1000 is obtained, here a turbomachine blade, formed from a fibrous reinforcement densified by a matrix which comprises in its lower part a root 1100b formed by the root part 11b of the fibrous blank 10 which is extended by a blade or an aerodynamic profile 1100a formed by the aerodynamic profile part 11a of the fibrous blank 10.

The component 1000 is preferably obtained by removing the sacrificial portion 1200 formed by the densified fibrous reinforcement from the sacrificial portion 12 of the fibrous blank 10.

The fibrous preform according to the present invention can in particular be used to produce a turbomachine blade having a more complex geometry than the blade shown in FIG. 6, such as blades including, in addition to that of FIG. 6, one or more platforms allowing to perform functions such as those of flow path sealing, anti-tilting, etc.

1. A fibrous preform produced in a single piece by three-dimensional weaving comprising a plurality of warp yarns extending in a longitudinal direction and a plurality of weft yarns extending in a transverse direction, said preform comprising in the longitudinal direction first and second portions connected by a transition portion, the first portion being thicker than the second portion in a thickness direction perpendicular to the transverse and longitudinal directions, each portion comprising, in the thickness direction, a core part provided between two surface parts, the core part of the first portion comprising a plurality of first warp yarns and a plurality of second warp yarns,
said fibrous preform comprising at least one plane perpendicular to the transverse direction in which the first warp yarns cross the second warp yarns in the transition portion.

2. The fibrous preform according to claim 1, wherein the core part of the first portion has a weave pattern different from the weave pattern of the core part of the second portion.

3. The fibrous preform according to claim 1, wherein the core part of the first portion comprises weft yarns having a larger section than the section of the weft yarns of the core part of the second portion.

4. The fibrous preform according to claim 1, wherein the surface parts of the first portion, the transition portion and the second portion have the same weave pattern.

5. The fibrous preform according to claim 1, wherein the first portion, the transition portion and the second portion comprise the same number of warp yarns in each plane of the preform perpendicular to the transverse direction.

6. The fibrous preform according to claim 1, each first warp yarn crosses each of the second warp yarns in the transition portion in said at least one plane of the fibrous preform perpendicular to the transverse direction.

7. The fibrous preform according to of claim 1, wherein each first warp yarn crossing a second warp yarn in the transition portion crosses in the transition portion all the second warp yarns crossing first warp yarns in said at least one plane of the fibrous preform perpendicular to the transverse direction.

8. The fibrous preform according to claim 1, wherein the core part of the first portion comprises a first and a second core part along the thickness direction, the first core part comprising the first warp yarns and the second core part comprising the second warp yarns.

9. The fibrous preform according to of claim 1, comprising at least one plane perpendicular to the transverse direction in which the transition portion comprises a plurality of successive weft columns Tₙ with n comprised between 1 and N, the weft column T₁ being the weft column adjacent to the first portion of the preform, N corresponding to the number of first warp yarns of the first portion crossing second warp yarns of the first portion, so that in the weft column Tₙ, n first warp yarns of the first portion cross n second warp yarns of the first portion.

10. A process for manufacturing a fibrous blank for a component made of composite material, the process comprising:
producing a fibrous preform according to claim 1,
shaping the fibrous preform so as to obtain a fibrous blank comprising an adjacent sacrificial portion and a useful portion, the sacrificial portion being formed at least by the first portion of the fibrous preform and the useful portion being formed by the second portion of the fibrous preform and at least part of the transition portion of the fibrous preform.

11. The process for manufacturing a component made of composite material comprising:
producing a fibrous blank in accordance with the process for manufacturing a fibrous blank according to claim 10,
introducing a composition comprising at least one precursor of a matrix material into the fibrous blank,
transforming the composition into a matrix so as to obtain an intermediate component made of composite material comprising a fibrous reinforcement densified by a matrix, the intermediate component comprising a sacrificial portion whose fibrous reinforcement is formed by the sacrificial portion of the fibrous blank,
removing the sacrificial portion of the intermediate component to obtain the final component.

12. A method comprising carrying out the process according to claim 11, for the manufacture of a turbomachine blade made of composite material.
